(19) United States
(12) Patent Application Publication
(10) Pub. No.: US 2005/0270139 A1
(43) Pub. Date: Dec. 8, 2005

(54) Automatic document transfer system and method thereof

(75) Inventors: Kyung-ho Park, Gyeonggi-do (KR); Woo-shik Kang, Gyeonggi-do (KR); Si-gyoung Koo, Seoul (KR); Jeong-joon Yoo, Gyeonggi-do (KR); Ji-hun Koo, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electro-Mechanics Co., LTD.

(21) Appl. No.: 11/144,754

(22) Filed: Jun. 6, 2005

(30) Foreign Application Priority Data
Jun. 4, 2004 (KR) 10-2004-0040899

(51) Int. Cl. G08C 19/00

(52) U.S. Cl. 340/5.61; 713/150; 726/3; 340/5.74; 340/10.1

(57) ABSTRACT

An automatic document transfer system and method are for transferring documents between a plurality of PCs connected to each other via a network, the system comprising: a first PC detecting an access of a user, monitoring whether the user accesses a document, and outputting the document in response to a predetermined command when the document is produced; a second PC detecting an access of the user and receiving the document by requesting the document via a network; and a monitoring server receiving the request from the second PC and outputting the command to the first PC to transfer the document.

### BACKGROUND OF THE INVENTION

This application claims the priority from Korean Patent Application No. 10-2004-0040899, filed on Jun. 4, 2004, in the Korean Intellectual Property Office, the disclosure of which is incorporated herein in its entirety by reference.

1. Field of the Invention

Systems and methods consistent with the present invention relate to automatic document transfer, and more particularly, to automatically transferring documents using a radio frequency identification (RFID) tag.

2. Description of the Related Art

As a conventional document transfer method, there exists a method of transferring documents by directly storing the documents on a diskette, moving the diskette, and reading the documents in a target personal computer (PC) or a method of transferring the documents using e-mail.

However, since these methods require user operations, it is cumbersome, and documents may be erroneously transferred due to a malfunction of a diskette or a mail server.

### SUMMARY OF THE INVENTION

The present invention provides a document transfer system and method for recognizing that a user having accessed a first PC moves to and starts to work on a second PC through RFID and transferring a document, which the user has accessed, to the second PC.

According to an aspect of the present invention, there is provided an system for transferring documents between a plurality of PCs connected to each other via a network, the system comprising: a first PC detecting an access of a user, monitoring whether the user accesses a document, and outputting the document in response to a predetermined command when the document is accessed; a second PC detecting an access of the user and receiving the document by requesting the document via a network; and a monitoring server receiving the request from the second PC and outputting the first PC to transfer the document.

According to another aspect of the present invention, there is provided a method of transferring documents between a plurality of PCs connected to each other via a network, the method comprising: confirming a first user accessing a first PC via a monitoring server; confirming a second user accessing a second PC via a monitoring server; if the first user is identical to the second user, the second PC determining whether the first user has accessed a document in the first PC using the monitoring server; if the first user has accessed the document in the first PC, the second PC requesting transfer of the document; and the first PC transferring the document to the second PC.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a document transfer system according to an exemplary embodiment of the present invention;

FIG. 2 shows an internal configuration of an RFID tag transmitting an RF signal to a reader of FIG. 1; and

FIG. 3 is a flowchart of a document transfer method according to an exemplary embodiment of the present invention.

### DETAILED DESCRIPTION OF THE EXEMPLARY EMBODIMENTS OF THE INVENTION

Hereinafter, the present invention will now be described more fully with reference to the accompanying drawings, in which exemplary embodiments of the invention are shown.

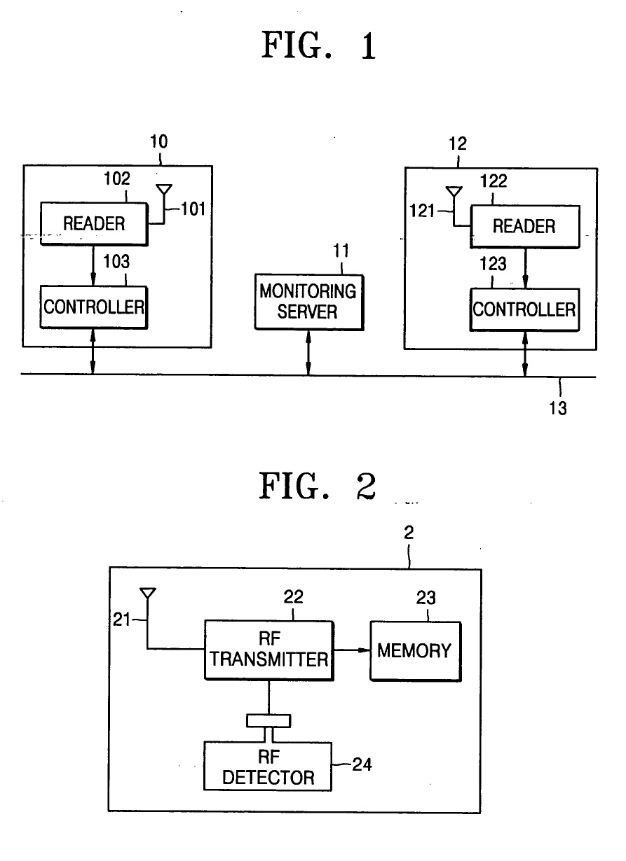

FIG. 1 is a block diagram of a document transfer system according to an exemplary embodiment of the present invention. Referring to FIG. 1, the document transfer system includes a first PC 10, a monitoring server 11, and a second PC 12, which are all connected to a network 13. Here, for convenience of description, only two PCs 10 and 12 are described for an example. However, in reality, a plurality of PCs or workstations connected to the network 13 can be included.

The first PC 10 and the second PC 12 include readers 102 and 122 and controllers 103 and 123, respectively.

The readers 102 and 122 transmit RF signals by predetermined periods via antennas 101 and 121 and receive RF signals in response to the transmitted RF signals, respectively. Alternatively, an infrared (IR) signal can be substituted for the RF signal.

A propagating distance of the RF signal transmitted from each of the readers 102 and 122 may be limited to a predetermined distance, for example, 1 meter. That is, each of the readers 102 and 122 transmits an RF signal to an object which accesses the readers and is located within the predetermined distance, and receives an RF signal from the object.

The received RF signal includes at least a user ID of the object accessing each of the readers 102 and 122.

FIG. 2 shows an internal configuration of an RFID tag 2 which belongs to a user and transmits an RF signal to the reader 102 or 202 of FIG. 1.

Referring to FIG. 2, the RFID tag 2 includes an antenna 21, an RF transmitter 22, a memory 23, and an RF detector 24. The RF detector 24 has a role of a switch to detect RF signals, which the readers 102 and 122 periodically transmit, and operate the RF transmitter 22. If an RF signal is detected by the RF detector 24, the RF transmitter 22 converts data, such as a user ID stored in the memory 23, into an RF signal and transmits the RF signal via the antenna 21.

Each of the readers 102 and 122 analyzes the RF signal received from the RFID tag 2 via each of the antennas 101 and 121 and detects a user ID of an object accessing each corresponding PC 10 or 12. If the corresponding PC 10 or 12 is not powered on when the corresponding reader 102 or 122 receives the RF signal, each of the first and second controllers 103 and 123 can boot (i.e., power on) the corresponding PC 10 or 12. If the booting is finished or the corresponding PC 10 or 12 is already powered on, each of the first and second controllers 103 and 123 transfers a user ID detected by the corresponding reader 102 or 122 to the monitoring server 11.

Since having user data including IDs of the users, the monitoring server 11 confirms which users are accessing which PCs by confirming user IDs transferred from the controllers 103 and 123 and the respective PCs 10 and 12. Also, the monitoring server 11 can confirm whether a same user has moved from the first PC 10 to the second PC 12 or reversely. For example, when a user has moved from the first PC 10 to the second PC 12, the second controller 123 detects data including a user ID from an RF signal received from the RFID tag 2 of the user and transfers the data to the monitoring server 11. The monitoring server 11 confirms that the user has moved from the first PC 10 to the second PC 12 by comparing the user ID received from the second PC 12 with a user ID received from the first PC 10 to determine whether the two user IDs are identical. If the user has moved from the first PC 10 to the second PC 12, the second controller 123 queries the monitoring server 11 whether the user accessing the second PC 12 has accessed documents in the first PC 10.

The first and second controllers 103 and 123 determine whether a predetermined user is currently accessing a document or has accessed the document by executing the document monitoring program. Here, the document monitoring program detects that a predetermined user executed an application program for accessing a document and finishes the application program. When the predetermined user finishes the application program, the document monitoring program informs the monitoring server 11 that the predetermined user has accessed the document via the corresponding controller 103 or 123.

If the predetermined user has accessed the document in the first PC 10, the monitoring server 11 commands the first controller 103 to transfer the to the document to the second PC 12. Accordingly, the first controller 103 transfers the document to the second PC 12.

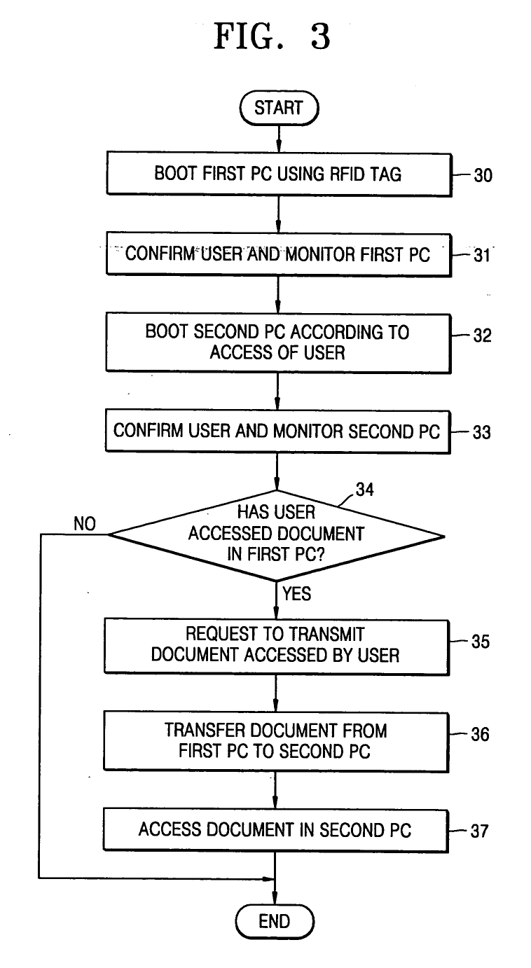

FIG. 3 is a flowchart of a document transfer method according to an exemplary embodiment of the present invention.

Initially, the reader 402 of the first PC 10, which a user accesses, receives an RF signal from the RFID tag 2 which is carried by the user, and if the first PC 10 is not powered on, the reader 102 transfers a ‘power on’ signal to the first controller 103 so that the first PC 10 can be booted, if necessary, in operation 30. The first controller 103 also transfers data including a user ID received from the RFID tag 2 to the monitoring server 11 via the network 13. The monitoring server 11 confirms that the user has accessed the first PC 10 through the user ID in operation 31.

When the user moves from the first PC 10 to the second PC 12, if the second PC 12 is not powered on, the second PC 12 can be booted using the RFID tag 2 of the user in operation 32 in the same manner as operation 31. The second controller 123 transfers data including the user ID to the monitoring server 11. The monitoring server 11 confirms that the user has moved from the first PC 10 to the second PC 12 by comparing the user ID transferred from the second controller 123 with the user ID transferred from the first controller 103 to determine that the two user IDs are identical in operation 33. The second controller 123 of the second PC 12 queries the monitoring server 11 whether the user has accessed a document in the first PC 10 in operation 34. The monitoring server 11 can determine whether the user has been accessing the document from the information received from the first controller 103, or by querying the first PC 10 whether there exists any document, which the user has accessed after being queried from the second controller 123.

If the document has been accessed in operation 34, the monitoring server 11 requests the first controller 103 to transfer the document, which the user has accessed, to the second PC 12 in operation 35. When the controller 103 of the first PC 10 transfers the document to the second PC 12 in operation 36, the user can continuously access the document in the second PC 12 in operation 37.

The document transfer method according to the present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transfer over the Internet). The present invention may be embodied as a computer-readable medium having a computer-readable program code unit embodied therein for causing a number of computer systems connected via a network to effect distributed processing. And the functional programs, codes and code segments for embodying the present invention may be easily deducted by programmers in the art which the present invention belongs to.

As described above, according to exemplary embodiments of the present invention, even though a user location is changed, the same document can be continuously accessed in another PC without inconvenience such as copying the document in a diskette, transferring the document using e-mail, or sharing the document or a directory. Also, when the user accesses the other PC, an additional identification process is not necessary by storing data including IDs of users in a monitoring server.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An system for transferring documents between a plurality of personal computers (PCs) connected to each other via a network, the system comprising:
a first PC which detects an access of a user, monitors whether the user accesses a document, and outputs the document in response to a command if the document is accessed;
a second PC which detects an access of the user and receives the document by generating a request for the document; and
a monitoring server which receives the request from the second PC and outputs the command to the first PC to transfer the document to the second PC via the network.

2. The apparatus of claim 1, wherein the first PC comprises:
a reader which senses a first signal including at least a user ID, and detects the user ID from the first signal; and
a controller which monitors whether the user having the user ID accesses the document, and outputs the document in response to the command.

3. The system of claim 2, wherein the reader periodically outputs a second signal having a propagating distance which is limited to a predetermined range.

4. The system of claim 3, further comprising a tag which outputs the first signal including at least the user ID in response to the second signal output from the reader.

5. The system of claim 4, wherein the tag comprises:
a detector which detects the second signal output from the reader;
a memory which stores the user ID;
a signal transmitter which reads the user ID from the memory in response to the second signal detected by the detector, converts the user ID into the first signal having an identical frequency to that of the second signal, and outputs the first signal to the reader.

6. The system of claim 1, wherein the second PC comprises:
a reader which senses a first signal including at least a user ID, and detects the user ID from the first signal; and
a controller which requests the first PC to transfer the document, which the user having the user ID has accessed in the first PC, and receives the document from the first PC.

7. The system of claim 6, wherein the reader periodically outputs a first signal having a propagating distance which is limited to a predetermined range.

8. The system of claim 7, further comprising a tag which outputs the first signal including at least the user ID in response to the second signal output from the reader.

9. The system of claim 8, wherein the tag comprises:
a detector which detects the second signal output from the reader;
a memory which stores the user ID;
a signal transmitter which reads the user ID from the memory in response to the second signal detected by the detector, converts the user ID into the first signal having an identical frequency to that of the second signal, and outputs the first to the reader.

10. The system of claim 1, wherein each of the first PC and the second PC obtains data of the user and outputs the data of the user to the monitoring server.

11. The system of claim 10, wherein at least one of the first PC and the second PC comprises:
a reader which senses a signal including at least a user ID, and detects the user ID from the signal which is sensed; and
a controller which outputs the user ID to the monitoring server.

12. The system of claim 10, wherein the monitoring server compares the data of the user input from the first PC and the data of the user input from the second PC, and commands the first PC to transfer the document to the second PC if the data of the user input from the first PC and the data of the user input from the second PC have identical user IDs.

13. A method of transferring documents between a plurality of personal computers (PCs) connected to each other via a network, the method comprising:
confirming, via a monitoring server, a first user is accessing a first PC;
confirming, via the monitoring server, a second user is accessing a second PC;
if the first user is identical to the second user, determining, via the monitoring server, whether the first user has accessed a document using the first PC;
if the first user has accessed the document using the first PC, requesting a transfer of the document to the second PC; and
transferring the document from the first PC to the second PC.

14. The method of claim 13, wherein the confirming of the first user comprises:
receiving a first signal including at least a first user ID from the first user and detecting the first user ID from the first signal;
transferring the first user ID from the first PC to the monitoring server; and
confirming the first user ID via the monitoring server.

15. The method of claim 14, wherein the confirming of the second user comprises:
receiving a second signal including at least a second user ID from the second user and detecting the second user ID from the second signal;
transferring the second user ID from the second PC to the monitoring server; and
confirming the second user ID via the monitoring server.

16. The method of claim 15, wherein the first signal including at least the first user ID is transmitted by the first user in response to a third signal which has a first propagating distance limited to a first predetermined range and is periodically output from the first PC.

17. The method of claim 16, wherein the second signal including at least the second user ID is transmitted by the second user in response to a fourth signal which has a second propagating distance limited to a second predetermined range and is periodically output from the second PC.

18. The method of claim 17, wherein the first PC is booted by the first signal transferred by the first user before the confirming of the first user ID or the second PC is booted by the second signal transferred by the second user the confirming of the second user ID.

19. The method of claim 15, wherein the determining of whether the first user has accessed the document using the first PC comprises:
the second PC querying the monitoring server whether the first user has accessed the document in the first PC; and
the monitoring server confirming whether the first user has accessed the document received from the first PC and the first user ID.

20. The method of claim 19, further comprising, before the determining of whether the first user has accessed the document in the first PC, the first PC informing the monitoring server that the first user has accessed the document.

21. The method of claim 15, wherein the determining of whether the first user has accessed the document in the first PC comprises:
the second PC querying the monitoring server whether the first user has accessed the document in the first PC;
the monitoring server querying the first PC whether the first user has accessed the document and receiving a response with respect to the querying from the first PC; and
the monitoring server informing the second PC of the response.

22. A computer-readable medium having recorded thereon a computer-readable program for performing the method of transferring documents between a plurality of PCs connected to each other via a network, the method comprising:
confirming, via a monitoring server, a first user accessing a first PC;
confirming, via the monitoring server, a second user accessing a second PC;
if the first user is identical to the second user, determining, via the monitoring server, whether the first user has accessed a document using the first PC;
if the first user has accessed the document using the first PC, requesting a transfer of the document to the second PC; and
transferring the document from the first PC to the second PC.
